(19) United States
(12) Patent Application Publication
(10) Pub. No.: US 2010/0190426 A1
(43) Pub. Date: Jul. 29, 2010

(54) LIVE BIRD SHACKLE TRANSFER SYSTEMS AND METHODS

(76) Inventors: Kok-Meng Lee, Norcross, GA (US); Billy Poindexter, II, Newnan, GA (US); A. Bruce Webster, Hull, GA (US); Shaohui Foong, Atlanta, GA (US); Chih-Hsing Liu, Atlanta, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/693,876

(22) Filed: Jan. 26, 2010

Related U.S. Application Data
(60) Provisional application No. 61/147,219, filed on Jan. 26, 2009.

(51) Int. Cl. A22C 21/00; A22B 1/00; A22C 18/00

(52) U.S. Cl. 452/53; 452/54; 452/182; 452/188; 452/150

(57) ABSTRACT

This document relates to live bird shackle transfer. In one embodiment, a live bird transfer system includes a perch conveyor, configured to transport a live bird on a perch mechanism from a distal end to a proximal end of the perch conveyor, and a shackle line, including a pallet assembly including a trolley supporting a pallet and a star-wheel mechanism configured to position the trolley such that the pallet is aligned with the proximal end of the perch conveyor during transfer of the live bird from the perch mechanism to the pallet. In another embodiment, a live bird transfer system includes a perch conveyor configured to transport a live bird from a distal end to a proximal end of the perch conveyor; a body-grasper at the proximal end of the perch conveyor; and virtual exit lighting positioned at the proximal end of the perch conveyor and above the body-grasper.

### CROSS REFERENCE TO RELATED APPLICATIONS

This application claims priority to copending U.S. provisional application entitled “METHODS OF LOADING LIVE BIRDS FROM CONVEYORS TO KILL LINE SHACKLES” having Ser. No. 61/147,219, filed Jan. 26, 2009, which is entirely incorporated herein by reference.

### BACKGROUND

Manual handling of live birds is a hazardous and unpleasant task. There are potentials for a variety of injuries to human handlers since the birds tend to flail about when they are caught. Potential injuries include: cuts and scratches that can easily become infected in a poultry processing environment; a variety of respiratory and visual ailments resulting from the high level of dust and feathers; hands or fingers can get caught in moving shackle lines; and repetitive motion disorders. The unpleasantness associated with the manual handling of live birds results in high employee turnover rates at some plants. The high turnover rate results in the need to constantly retrain new employees. In addition, manual handling of live birds may lead to bruising and downgrading of the birds.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 illustrates a system for mechanically transferring live birds to a shackle line in accordance with an embodiment of the disclosure.

FIG. 2 is a cross-sectional view of a perch conveyor of FIG. 1 in accordance with an embodiment of the disclosure.

FIGS. 3A-3C illustrate an exemplary embodiment of perch mechanisms mounted the perch-conveyor of FIG. 2 in accordance with an embodiment of the disclosure.

FIG. 4 is a graphical representation of the geometrical relationships between a pallet, a body-grasper, and the perch conveyor of FIG. 1 in accordance with an embodiment of the disclosure.

FIGS. 5A-5B illustrate the geometrical parameters of a cam mechanism that manipulates a perch mechanism of FIGS. 3A-3C in accordance with an embodiment of the disclosure.

FIGS. 6A-6C illustrate exemplary embodiments of shackle mechanisms in accordance with embodiments of the disclosure.

FIGS. 7A-7C illustrate same-plane rotation of a pallet of FIG. 1 in accordance with an embodiment of the disclosure.

FIG. 8 is a flowchart that illustrates the sequential transfer of birds from the perch conveyor to a shackle line of FIG. 1 in accordance with an embodiment of the disclosure.

FIGS. 9A-9C are views of an exemplary live bird transfer system of FIG. 1 in accordance with an embodiment of the disclosure.

FIGS. 10A-10B illustrate an embodiment of a star-wheel design of the shackle line of FIGS. 9A-9C in accordance with an embodiment of the disclosure.

FIGS. 11A-11B are graphical representations of a control system for the transfer system of FIG. 1 in accordance with an embodiment of the disclosure.

FIG. 12 is a graphical representation of the relationships between the controlled drum speed of the body-grasper, speed of the perch conveyor, and the effect of gravity on the bird in accordance with an embodiment of the disclosure.

### DETAILED DESCRIPTION

Disclosed herein are various embodiments of systems and methods related to live bird shackle transfer. Reference will now be made in detail to the description of the embodiments as illustrated in the drawings, wherein like reference numbers indicate like parts throughout the several views.

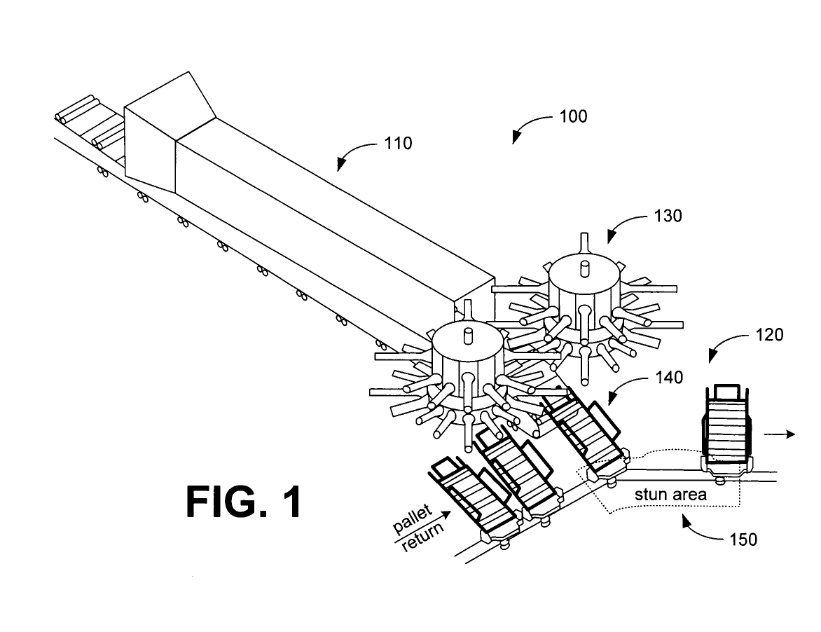

With regard to FIG. 1, shown is an embodiment of a system 100 for mechanically transferring live birds, such as chickens, to a shackle line. The live bird transfer system (LBTS) 100 can remove humans from the repetitive tasks of (1) grasping both legs of a bird, (2) inverting and lifting of the bird by its legs, and (3) inserting the grasped legs into the moving shackle. The LBTS includes a perch conveyor 110 that transports arriving birds to a shackle line 120. A body-grasper 130, including counter rotating drums with fingers, cradles a bird as it travels to the end of the perch conveyor 110, where the bird is shackled to a pallet 140 on the shackle line 120. A body-grasper 130 is further described in U.S. Pat. No. 7,134,956, issued on Nov. 14, 2006 and entitled “AUTOMATED FEET-GRIPPING SYSTEM”, which is hereby incorporated by reference in its entirety.

The shackled bird rolls onto the pallet 140 as it is released from the body-grasper 130, inverting the bird for further processing. When loaded, the pallet 140 is moved down the shackle line 120 and replaced by the next empty pallet 140. The inverted bird may then be electrically stunned 150 to minimize (or eliminate) the opportunity for wing-flaps or other movement of the bird during processing. After processing in complete, empty pallets 140 are returned on the shackle line 120.

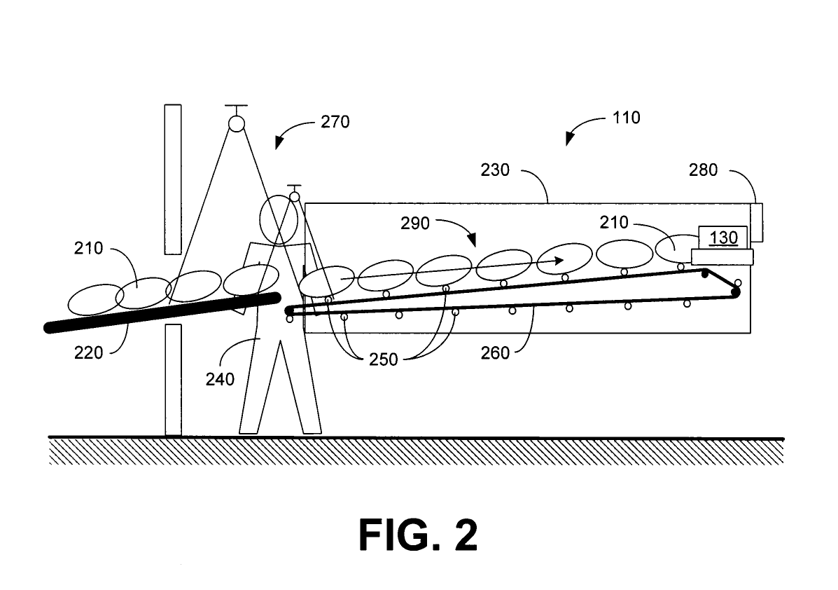

Referring next to FIG. 2, shown is a cross-sectional view of the perch conveyor 110 of FIG. 1 in accordance with one embodiment of the disclosure. Birds 210 are loaded (e.g., from cages) onto a dock-conveyor 220, which may be located outdoors, and subsequently transported indoors to the perch conveyor 110. In general, a wider, slow moving dock conveyor 220 is utilized to transport birds 210 to the narrower, fast moving the perch conveyor 110. In the embodiment of FIGS. 1-2, the perch conveyor 110 is an enclosed conveyor. In some embodiments, one or more sides of the conveyor enclosure 230 may be transparent or include openings to allow for observation of the birds 210 during transport within the conveyor enclosure 230. A human worker 240 removes birds that are dead-on-arrival (DOA) and positions birds 210 to face forward on perch mechanisms 250 of the perch conveyor 110. In the embodiment of FIG. 2, incoming birds 210 perch directly on equally spaced perch mechanisms 250 mounted on the belt 260 of perch-conveyor 110.

Experiments suggest that live birds 210 prefer to perch while avoiding slippery surfaces. They also tend to face forward when transported uphill. Based on these observations, the dock conveyor 220 and/or a portion 290 of the perch conveyor 110 may be designed to incline upwards as illustrated in FIG. 2. The incline angle (β) may be in the range of about 2 degrees to about 25 degrees, about 3 degrees to about 15 degrees, or about 5 degrees to 10 degrees. In one embodiment, the incline angle (β) is about 5 degrees. In addition, the incline portion 290 of the perch conveyor 110 may be designed to so that the incoming birds 210 do not see the shackling process at the end of the perch conveyor 110.

Structured lighting 270 is provided to minimize (or eliminate) the birds' 210 potential reactions to darkness (e.g., a tendency to turn back) at the entrance and transition from the dock conveyor 220 to the perch conveyor 110. The entrance region on the perch conveyor 110 (i.e., where empty perch mechanisms 250 return to receive the next incoming birds 210) is locally illuminated to reduce the brightness difference between the conveyor connection. The local lighting effect is designed to help the bird 210 see the empty perch mechanism 250 (which may include a friction surface) while discouraging the bird 210 from landing on other smooth surfaces of the belt 260. For example, LED arrays, fluorescent lamps, and/or spot lights may be positioned to focus the emitted light on the dock and perch conveyors (220 and 110). In some embodiments, the structured lighting 270 may be positioned to limit the illumination of the surrounding area.

To facilitate human worker(s) 240 to position birds 210, the illumination source of the structured lighting 270 may be chosen such that it is visible to human (about 400 nm to about 700 nm) but spectrally insensitive to birds, e.g. chickens. Research indicates that the visual cones of most avian retinas contain brightly colored oil droplets in their inner segments, immediately adjacent to the outer segments. Therefore, most light reaching the outer segments has probably passed through a corresponding oil drop. This anatomical arrangement has led to the suggestion that the droplets (orange, yellow, or red) act as intraocular light filters, intensifying similar colors while reducing the discrimination of other colors, such as violet and blue. In one embodiment, blue light in the range of about 425 nm to about 450 nm is employed.

In addition, virtual exit lighting 280 is provided to create an environment that encourages the birds 210 to face forward in the perch conveyor 110 and minimizes (or eliminates) the potential reaction of the birds 210 to the rotating fingers of the body-grasper 130. The virtual exit lighting 280 is positioned above the body-grasper 130 at the exit of the perch conveyor 110. The combination of the structured lighting 270 and the virtual exit lighting 280 maintains “darkness to birds” within the enclosed perch conveyor 110 except for a brightly illuminated virtual exit at the downstream exit of the perch conveyor 110. The illuminated virtual exit lighting 280 masks the rotating fingers of the body-grasper 130 from the birds 210. In one embodiment, a blue light with a spectral range or about 425 nm to about 450 nm is used to expose the incoming birds 210 to a non-discriminating bright light. For example, virtual exit lighting 280 may include an LED array to provide the brightly illuminated virtual exit. Alternatively, fluorescent or other appropriate lamps with a blue light filter (such as, e.g., a Roscolux Full Blue Filter) may be used.

To keep a bird 210 from flailing and maintain consistent posture during the transfer process, the bird's visual reaction to changes is reduced by the combination of the structured lighting 270 and the virtual exit lighting 280 in two stages. During the first stage, the bird 210 is light adapted as it moves up the inclined portion 290 of the perch conveyor 110 towards the brightly illuminated virtual exit lighting 280, thereby reducing the bird's visual contact with the rotating fingers of the body-grasper 130. Once the bird 210 is cradled by the body-grasper 130, the bird 210 is manipulated during the second stage to face forward and then downward. During this second stage, the bird 210 experiences new darkness while its feet are being shackled. The shackling process occurs over a short time interval of about 0.25 second (before the bird's vision is adapted to the new darkness).

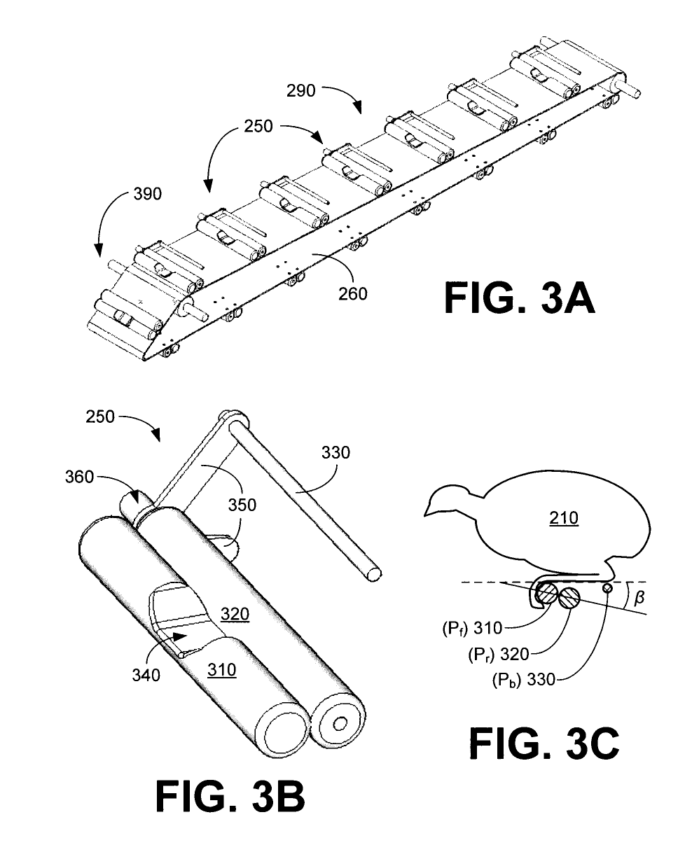

Referring next to FIGS. 3A-3C, shown is an exemplary embodiment of the perch mechanisms 250 mounted on the belt 260 of perch-conveyor 110. FIG. 3A illustrates perch mechanisms 250 (that move with the perch conveyor 110) for controlling the sitting posture of the bird 210. Each of the exemplary perch mechanisms 250 includes two circular rods—front perch rod (P_{f}) 310 and rear perch rod (Pᵣ) 320—as well as a cam-operated rotational trap-bar (P_{b}) 330. As shown in FIG. 3B, the front perch bar 310 may be shaped to include a recess 340 in the center to separate the feet, while rear perch bar 320 and trap-bar 330 support the legs of the bird 210. Trap-bar 330 is supported on one end by a cam mechanism 350, which can be rotated about a pivot point 360 such that a bird 210 sits on a horizontal plane as illustrated in FIG. 3C, where both shanks of the bird legs are supported on Pᵣ 320 and/or P_{b} 330, while traveling on the incline portion 290 of the perch conveyor 110.

The trap-bar 330 also manipulates the bird legs to help the bird 210 stand on P_{f} 310 and/or Pᵣ 320 as the bird travels between the body-grasper 130 (FIG. 2) and along a decline portion 390 of the perch conveyor 110. The standing pose provides the opportunity to shackle both legs of the bird 210 to a pallet 140 located on the shackle line 120 (FIG. 1). As the perch mechanism 250 moves forward, the trap-bar (P_{b}) 330 rotates both shanks of the bird 210 (about their respective hocks) during the shackling process. Once both shanks of the legs are shackled, the trap-bar 330 returns to its original position to clear the pallet 140 as the perch mechanism 250 passes to the bottom of the perch conveyor 110 (FIG. 1).

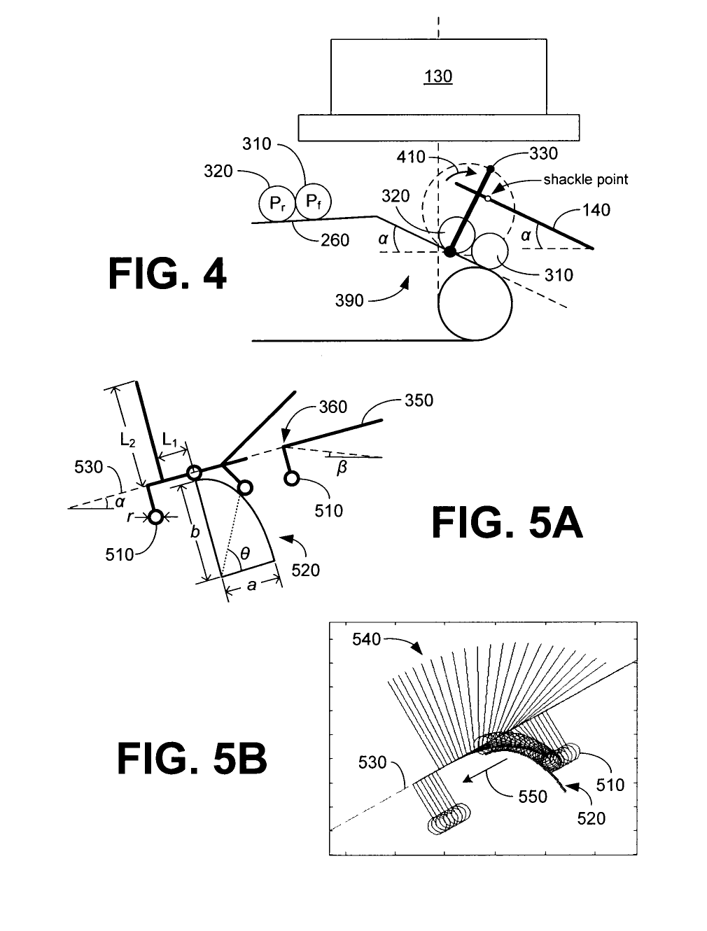

FIG. 4 is a graphical representation of the geometrical relationships among the pallet 140, body-grasper 130, and perch conveyor 110. A mechanized track for driving the pallets 140 on the shackle line 120 (FIG. 1) includes an indexer and a positioning device to synchronize a shackle mechanism of the pallet 140 with the body-grasper 130. At the beginning of each cycle, a pallet 140 is positioned below the body-grasper 130 mounted at the end of the perch-conveyor 110. The arrival of the bird 210 signals the rotating hands of the body-grasper 130 to grasp the bird 210 by its body while allowing both feet of the bird 210 to descend with the declined portion 390 of the perch conveyor 110 towards the shackle mechanism of the pallet 140. The decline angle (α) may be in the range of about 15 degrees to about 45 degrees, about 20 degrees to about 40 degrees, or about 25 degrees to 35 degrees. In one embodiment, the decline angle (α) is about 30 degrees. The trap-bar (P_{b}) 330 then rotates (arrow 410), which helps the bird 210 stand on P_{f} 310 and/or Pᵣ 320, while the perch conveyor 110 drives the shanks of bird 210 into the shackle mechanism of the pallet 140.

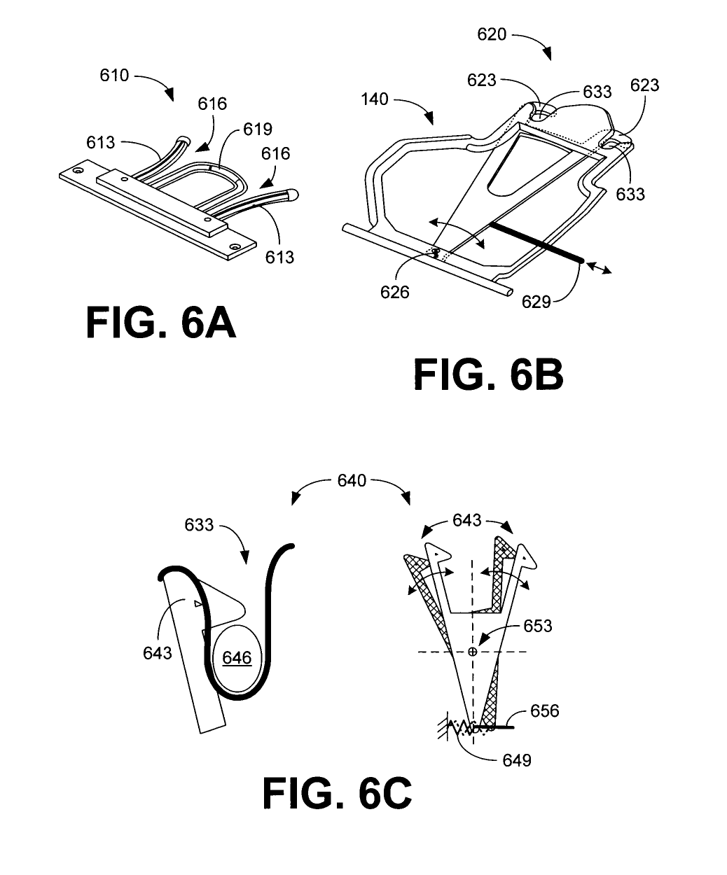

Referring next to FIGS. 5A-5B, shown are the geometrical parameters of the cam mechanism 350, that manipulates the trap bar 330, and its simulated motion as a perch mechanism 250 is moved along the decline portion 390 (FIG. 4) of the perch conveyor 110. As illustrated in FIG. 5A, the L-shaped cam mechanism 350 (of lengths L₁ and L₂) is manipulated by rotating about the pivot point 360 as a follower 510 (e.g., a roller of radius r) rolls and/or slides on an elliptical cam profile 520 (with minor and major radii of a and b, respectively). As the perch mechanisms 250 move along the decline portion 390, the motion of pivot point 360 follows along line 530. Movement of the follower 510 along the cam profile 520 provides a smooth rotation of the cam mechanism 350 while reducing (or minimizing) the contact force N exerted on follower 510 to produce the trap-bar 330 motion path 540 (FIG. 6B) within a specified time.

In the exemplary embodiment of FIGS. 5A-5B, the pivot point 360 is driven along the decline portion 390 (e.g., α=30°) at a speed (V) as indicated by arrow 550. As the pivot point 360 travels along line 530, the follower 510 moves along the elliptical cam profile 520 from an initial contact point (e.g., at θ=π/6 or 30°) to the highest point on the cam 520, after which the follower 510 is free from contact with the cam profile 520, and the trap-bar 330 returns by gravity (or under the influence of an external control force) to a rest position. For example, with a cam mechanism 350 having a length of L₁=1 inch, a follower radius of r= 3/16 inch, and traveling at a speed of V=18 inches/second, one exemplary cam design may have the following geometry: a=1.5 and b=2 (in inches). In this exemplary embodiment, trap-bar 330 takes approximately 0.13 seconds to complete the rotation (from initial contact to completely reset) as illustrated in FIG. 5B, during which the pivot point 360 travels approximately 2 inches horizontally.

As the trap-bar 330 rotates, helping the bird 210 stand and straighten its legs, the shanks of bird 210 are inserted into the shackle mechanism of the pallet 140. Referring to FIGS. 6A-6C, shown are three exemplary embodiments of shackle mechanisms that may be utilized on pallet 140. FIG. 6A illustrates a compliant gripper 610, including a pair of compliant curved beams 613. As each leg of the bird 210 is rotated by trap-bar 330 into a gripping area 616, the compliant beam 613 deflects and grips the shank against the rigid U-shaped bar 619.

FIG. 6B illustrates an alternate shackle mechanism 620 design for locking both shanks of the bird 210 to an exemplary pallet 140. The externally controlled shackle mechanism 620 consists of two hooks 623 on a plane which can be rotated about a compliant pin-joint 626. The hooks 623 are normally closed in the locking position under the compliant torsion of the pin-joint 626. A mechanical control 629 is used to open the hooks 623 by applying a counter force. The hooks 623 are opened to allow the trap-bar 330 to push the shanks of the bird 210 into the gripping areas 633 for shackling and to release the shanks during subsequent processing.

FIG. 6C illustrates another shackle mechanism 640, which is similar to the shackle mechanism 620 of FIG. 5B. The bird operated shackle mechanism 640 of FIG. 6C includes hooks 643 that self-lock on the shanks 646 of the bird 210. Spring 649 provides a locking torque about pivot point 653. When the shanks 646 of the bird 210 are rotated by trap-bar 330 and pushed into the gripping areas 633, the shanks 646 provide a counter force that rotates the hooks 643 to allow the shanks to enter the gripping areas 633. As the shanks 653 move past the hooks 643, spring 649 returns hooks 643 to their original position to lock the shanks 646 of the bird 210 in position. As in the shackle mechanism 620 of FIG. 5B, a mechanical control 656 is used to open the hooks 643, by applying a counter force, to release the shanks 646 during subsequent processing.

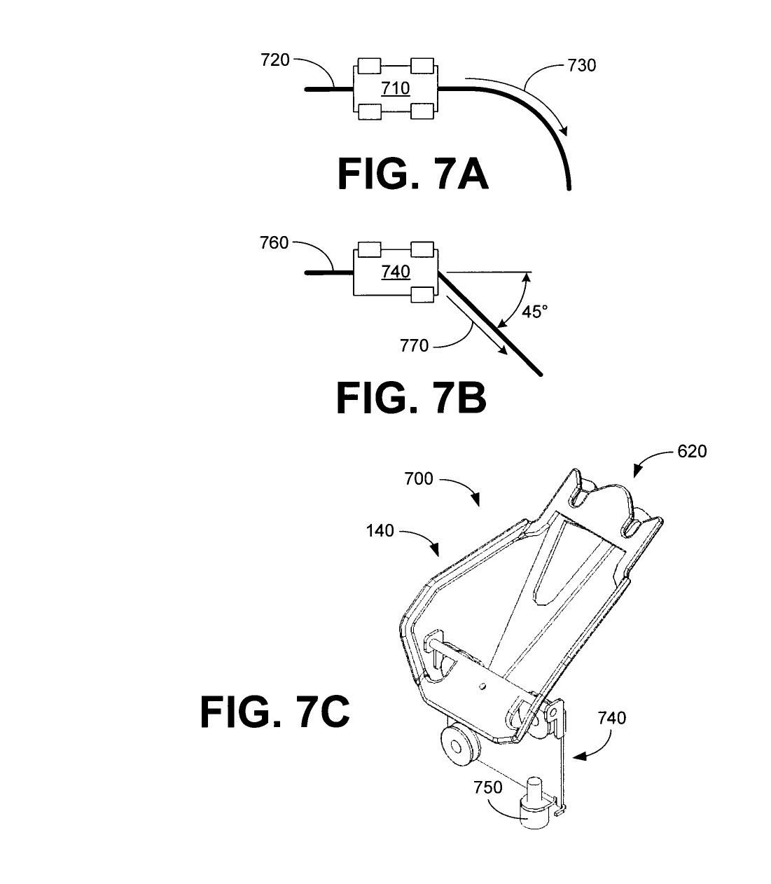

Once the bird 210 is shackled to the pallet 140, the bird 210 and pallet 140 is cleared to allow shackling of the next bird 210. Since the trap-bar 330 and the pallet 140 are driven on separate tracks (perch conveyor 110 and shackle line 120 respectively), the shackled feet of the bird 210 are cleared from the trap-bar 330 before positioning another pallet 140 to pick up the next bird. For example, the shackled bird 210 can be cleared utilizing same-plane rotation of the pallet 140. Referring now to FIGS. 7A-7C, shown are embodiments for same-plane rotation of the pallet 140. In one embodiment, the same-plane rotation can be accomplished by a circular track 720 along which a conventional four-wheel trolley 710 carrying the pallet 140 negotiates the curve (arrow 730) as illustrated in FIG. 7A. Alternatively, a three-wheel trolley 740 design (as illustrated in FIG. 7B) negotiating (arrow 770) an angled track 760 allows for a quick rotation to clear the trap-bar 330, which may be more effective for reducing cycle time. FIG. 7C illustrates an exemplary embodiment of a pallet assembly 700 including a three-wheel trolley 740 configured to support an exemplary pallet 140 including, for example, the shackling mechanism 620 of FIG. 6B.

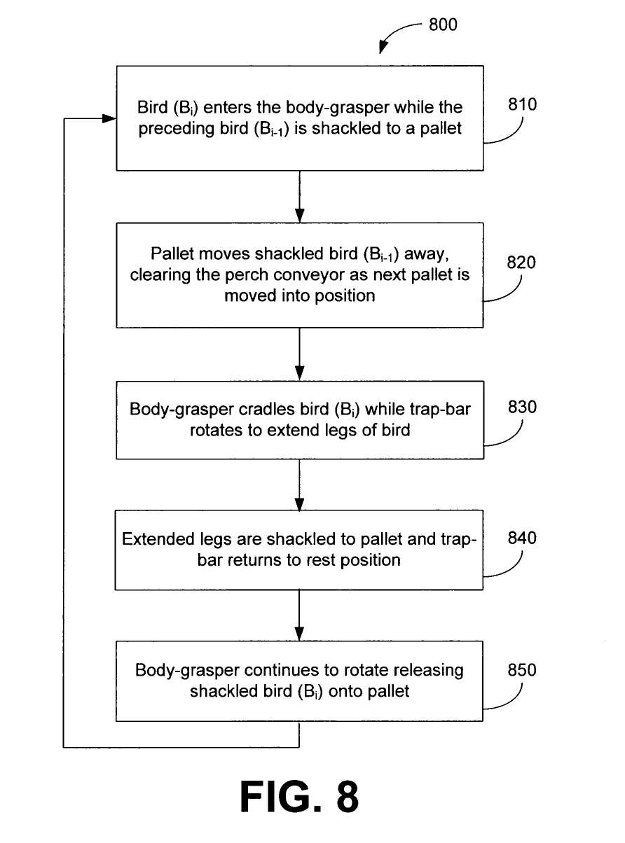

Referring to FIG. 8, shown is a flowchart 800 that illustrates the sequential transfer of birds 210 from the perch conveyor 110 to the shackle line 120. In block 810, a bird 210 (Bᵢ) enters the body-grasper 130 when the preceding bird 210 (Bᵢ₋₁) is shackled to a pallet 140. The pallet 140 and shackled bird 210 (Bᵢ₋₁) is moved away to clear the perch conveyor 110 for the next pallet 140 in block 820. The next pallet 140 may be simultaneously moved into position over the perch conveyor 110 to receive the bird 210 (Bᵢ). In block 830, body-grasper cradles the bird 210 (Bᵢ) as trap-bar 330 rotates to extend legs for shackling. The extended legs are shackled to pallet 140 in block 840 by driving the shanks of the bird 210 (Bᵢ) into the gripping areas of the shackle mechanism. Both shanks may be locked in place and the trap-bar returns to its rest position as it moves along the perch conveyor 110. The body-grasper 130 continues to rotate releasing the shackled bird 219 (Bᵢ) onto the pallet 140 in block 850 and the sequence returns to block 810. In some embodiments, the operations of blocks 810 and 850 occur at the same time.

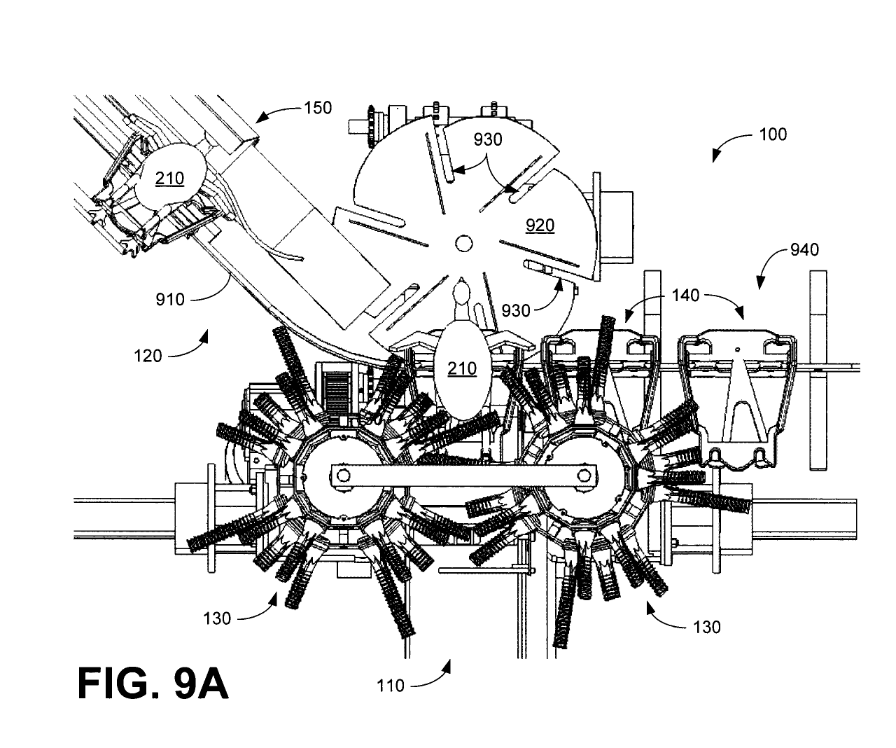

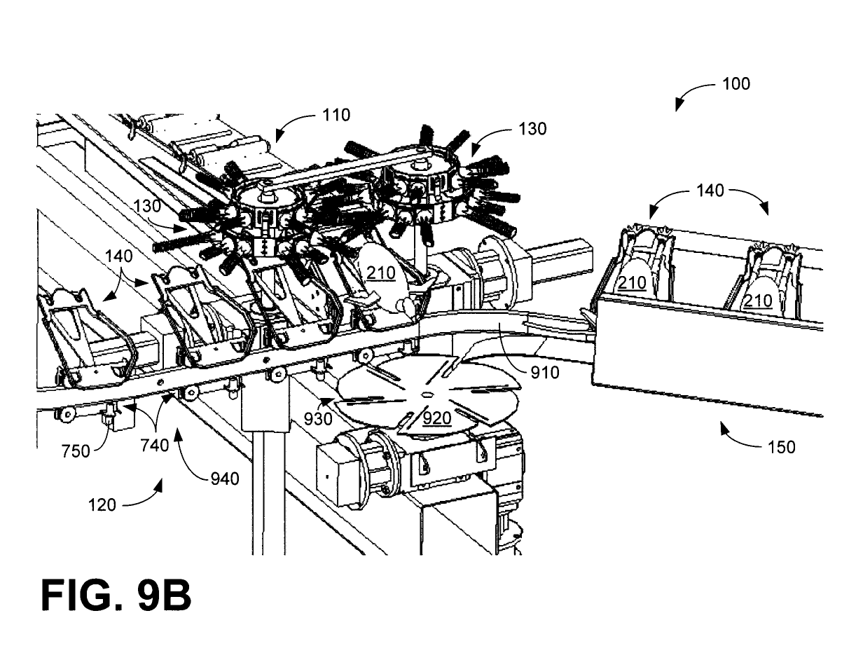

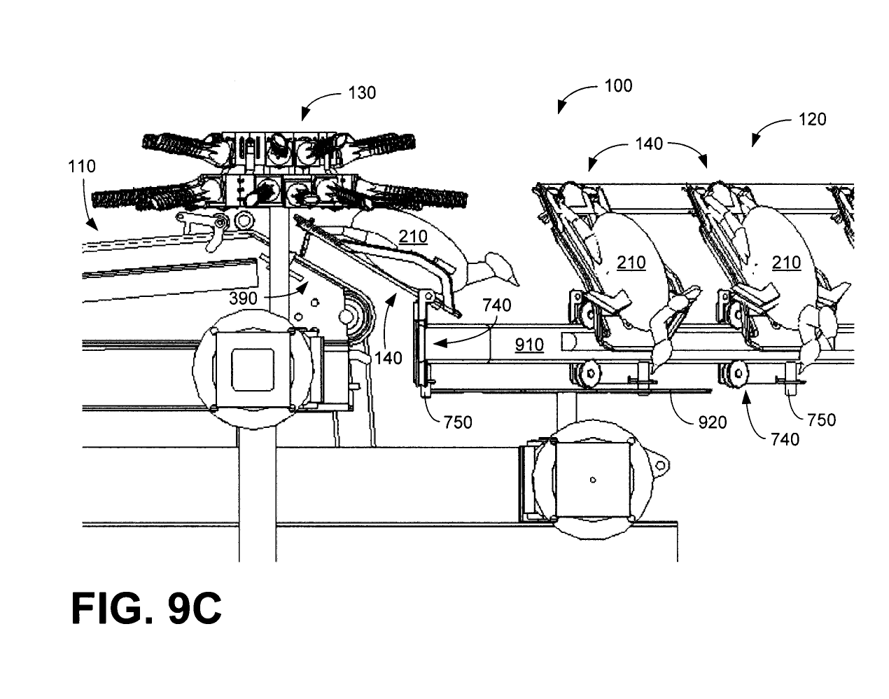

To support the bird 210 after it is released from the body-grasper 130, the pallet 140 is positioned approximately parallel to the decline portion 390 (FIGS. 3A and 9C) of the perch-conveyor 110 (e.g., at a 30° angle) as illustrated in FIG. 1A. The body of the shackled bird 210 rolls over the pallet 140 as it is released from the body-grasper 130 (FIG. 2). As the bird 210 is released from the body-grasper 130, the bird 210 is inverted. This is accomplished by rotating the combined pallet 140 and bird 210 in the same-plane, followed by an additional rotation from horizontal (e.g., from a 30° angle to 60° angle). The body of the bird 210 is fully supported throughout the inversion by rotating about an axis near its center of gravity of the bird. The short cycle-time (which is shorter than the bird's reaction time) and the near-center of gravity, body-supported inversion, along with an immediate electrical stunning, minimizes (or eliminates) the opportunity of wing-flaps during the transfer. Once the bird 210 is fully inverted, the head of the bird 210 may be guided into an electrical saltwater stun-bath, where the bird is immediately rendered insensitive to pain.

As the bird 210 exits the body grasper 130, the exit velocity of the bird 210 (and thus its position and orientation) depends on the forces acting on the bird 210 due to the fingers of body-grasper 130 and gravity. The exit position and/or orientation of the bird 210 can be broadly divided into three phases:
During the initial phase, the bird 210 exits the body-grasper 130 with an initial velocity in the horizontal plane from the conveyor motion and the finger forces.
Once the bird 210 is free from the fingers of the body-grasper 130, it descends following a parabolic path in the second phase due to gravity, which is the sole force acting on the bird 210.
Because the hock joints are shackled, the bird 210 rotates and lands onto the pallet 140. The horizontal motion of the bird 210, which is constant, extends the leg joints of the bird 210.
   Due to the constant gravitational force, the vertical (Y-direction) displacement is constant for all exit velocities, while a higher exit velocity generates a larger horizontal displacement (in the X-direction) and also larger angular orientation of the bird 210.

The flow chart of FIG. 8 shows the architecture, functionality, and operation of a possible implementation of the live bird transfer system (LBTS) of FIG. 1. In this regard, each block represents a module, segment, or portion of code, which comprises one or more executable instructions for implementing the specified logical function(s). It should also be noted that in some alternative implementations, the functions noted in the blocks may occur out of the order noted in FIG. 8. For example, two blocks shown in succession in FIG. 8 may in fact be executed substantially concurrently, depending upon the functionality involved.

Referring next to FIGS. 9A-9C, shown are views of a live bird transfer system 100 for transferring birds 210 between the perch conveyor 110 and the shackle line 120 according to an embodiment of the current disclosure. Perch conveyor 110 transports live birds 210 to body-grasper 130, which cradles a bird 210 as it travels to the end of the perch conveyor 110, where the bird is shackled to a pallet 140 on the shackle line 120. A four-wheel trolley 710 or a three-wheel trolley 740 may be use to support the pallet 140. In the embodiment of FIGS. 9A-9C, the pallet assembly 700 of FIG. 7C including the three-wheel trolley 740 is utilized. Referring back to FIG. 7C, the three-wheel trolley 740 includes three rollers, which constrain the trolley 740 (and thus the pallet 140) to translate along a track 910 (FIGS. 9A-9C), and a follower 750 fixed at the front of each trolley 740.

The shackle line 120 includes a star-wheel mechanism 920 for feeding and positioning the pallets 140 along the track 920 relative to the perch conveyor 110. The star-wheel mechanism 920 includes a servomotor-driven rotating wheel with equally spaced radial slots as illustrated in FIG. 9A. The radial slots 930 engage with follower 750 to draw a pallet into position and then to clear the shackled bird 210 and the pallet 140 from the decline portion 390 of the perch conveyor 110. A typical cycle of operation includes:
Incoming pallets 140 are fed (e.g., by gravity) to an accumulating region 940.
When the follower 750 of a trolley 740 engages one of the radial slots, the pallet 140 is moved along the track 910 as the star-wheel mechanism 920 rotates to the target position aligned with the perch conveyor 110. The follower 750 is free to translate along the slot 930 to allow translation of the rotational motion of the star-wheel mechanism into linear motion of the trolley 740 along track 910. An indexing command is provided by a master controller to position the star-wheel mechanism 920, and thus the trolley 740 and pallet 140 with respect to the perch conveyor 110.
While the pallet 140 is held stationary by the star-wheel mechanism 920, the rotating fingers of the body-grasper 130 momentarily cradle the bird 210 as it passes between the two drums. As the bird 210 travels to the end of the decline portion 390 of the perch conveyor 110, both shanks of the bird 210 are guided into the shackle mechanism of the pallet 140.
After the bird 210 is shackled to the pallet 140, the star-wheel mechanism 920 rotates (under the indexing command of the master controller) to move the shackled bird 210 away the perch conveyor 110. As the star-wheel mechanism 920 moves the trolley 740 along track 910, the follower 750 becomes free from the star-wheel mechanism 920 and the pallet 140 with the shackled bird 210 is transferred to next handling process (e.g., where the bird is stunned 150) by a separate conveyor (not shown).

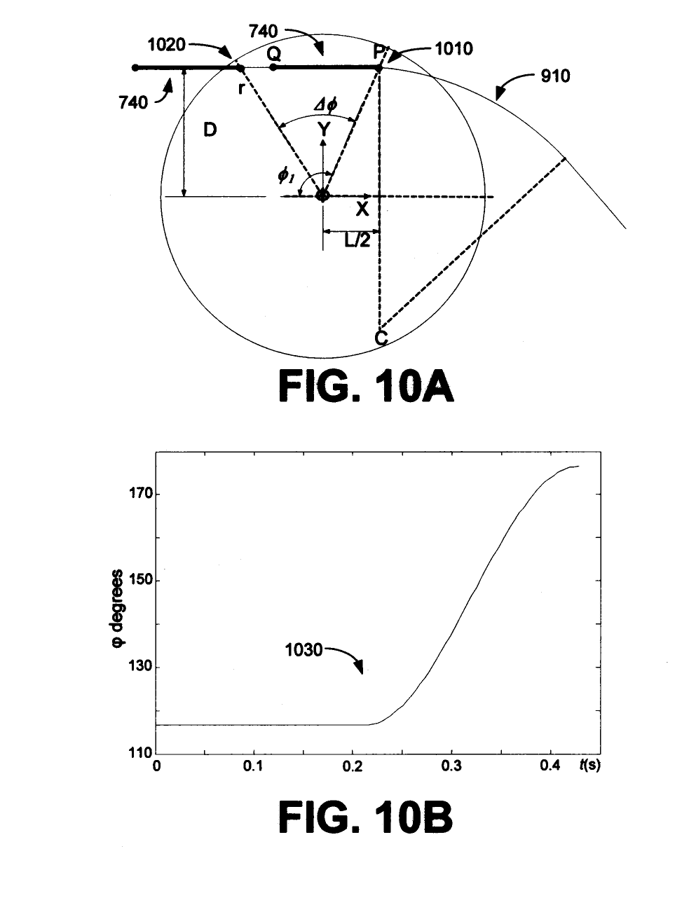

Referring to FIG. 10A, shown is an exemplary embodiment of a star-wheel design. The wheel diameter and the number of radial slots 930 may be designed to minimize the inertia while meeting the throughput requirements of the transfer system. In the embodiment of FIG. 10A, the star-wheel engages the follower 750 of a trolley 740 (at point P 110 with both ends of the trolley 740, P and Q, in contact with the track 910) while in position to grip the legs of the bird 210 during transfer. The follower 750 of the next trolley 740 is engaged with the star-wheel at point r 1020 and ready to be moved into position to receive the next bird 210. Each motion cycle of the star-wheel includes a first part (time period from 0 to T₁), where the shackling mechanism of a pallet 140 is held in alignment with the perch mechanisms 250 of the perch conveyor 110, and a second part, where the star-wheel mechanism 920 is rotated to clear the loaded pallet 140 and bring the next pallet 140 into position to receive the next bird 210. The rotational angle (φ) of FIG. 10A can be expressed as:

$$ϕ ( t ) = \{ \begin{matrix}{φ}_{1} = π - {tan}^{- 1} ( 2 D / L ) & t ∈ [ \begin{matrix}0 & {T}_{1}\end{matrix} ] \\ {φ}_{1} + \frac{Δφ}{2} [ 1 - cos ( \frac{π ( t - {T}_{1} )}{T - {T}_{1}} ) ] & t ∈ [ \begin{matrix}{T}_{1} & T\end{matrix} ]\end{matrix}$$

FIG. 10B illustrates the change in rotational angle for one exemplary operation of the star-wheel of FIG. 10A. Line 1030 is a plot of the rotational angle ((φ) during the first period where the rotational angle is held constant and the second period where the star-wheel mechanism is rotated to clear the loaded pallet 140 and move the next pallet 140 into position.

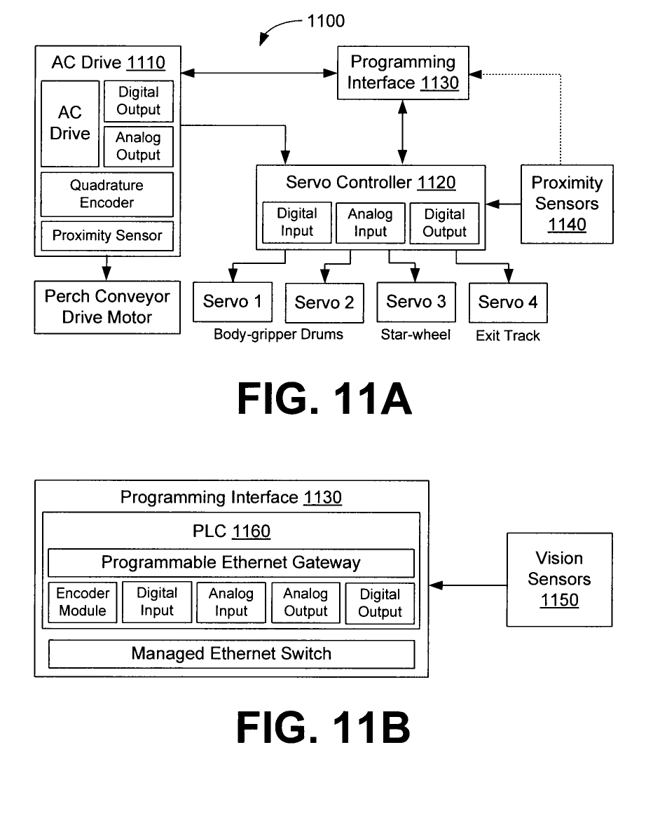

Referring next to FIGS. 11A-11B, shown is an exemplary control system 1100 for the live bird transfer system (LBTS) 100. The control system 1100 of FIG. 11A includes an AC drive 1110 controlling the motion of the perch conveyor 110, and a four-axis servo controller 1120 independently controlling the pair of rotating drums of the body-grasper 130, the star-wheel mechanism 920, and subsequent motion along exit track 910. The AC drive 1110 is set to a predetermined constant speed (e.g., using a manual reference input), which is relayed to the servo controller 1120 via electrical connections between the I/O ports of the AC drive 1110 and servo controller 1120. The AC drive 1110 and servo controller 1120 can be programmed using a programming interface 1130, (such as, but not limited to, a computer, programmable logic control (PLC), or other appropriate processing device) using USB/RS 485 and/or Ethernet connections. A safety controller can be included to cease all operations and/or remove power in emergencies. One or more proximity sensors 1140 are also included. For example, in some embodiments:
A first sensor detects the incoming birds 210 as they approach the body-grasper 130.
A second sensor detects a successful leg grasping (or shackling) motion, which is used to initiate the star-wheel rotation to transfer the shackled bird 210 to clear the pallet 140 out of the shackling area.
A third sensor detects the exit of the follower 750 from the slot 930 of the star-wheel mechanism 920, and commences the motion of the trolley 740 along exit track 910 to extract the shackled bird 210 for subsequent processing.
   The output signals of the sensors 1140 are supplied directly to the servo controller 1120.

In a typical cycle, the perch conveyor 110 is operated at a specified speed (e.g., 18.67 in/s), and this velocity data is transmitted to the servo controller 1120. When a bird 210 traveling on the perch conveyor 110 reaches a specified critical distance from the drums of the body-grasper 130, the detection by the first proximity sensor initiates a motion profile of the rotating drums of the body-grasper 130 to cradle the bird 210 and assist in leg shackling. Upon detection of successful leg shackling by the second proximity sensor, the motion of the star-wheel mechanism 920 to rotate the pallet 140 with the shackled bird 210 out of the shackling area and usher an empty pallet 140 into position to receive the next bird 210. When the trolley 740 carrying the loaded pallet 140 exits the star-wheel, the final proximity sensor triggers an exit track servo to perform body inversion of the bird 210 and transfer the loaded pallet 140 for further processing.

While the control system 1100 shown in FIG. 11A can be controlled using the described control configuration, a more advanced control configuration may include data collection for off-line analysis and intelligent control through the use of machine vision. FIG. 11B illustrates the more advanced control configuration for the control system 1100 of FIG. 11A including vision sensors 1150. For example, four vision sensors may be installed to provide feedback image information for the live bird transfer system (LBTS) 100: Two cameras may be installed before the rotating drums of the body-grasper 130 to monitor side and top views of a bird 210 entering the body-grasper 130. A third camera may be installed to scrutinize the leg shackling operation while the fourth camera may examine the subsequent body inversion process.

FIG. 11B shows an exemplary embodiment where the programming interface 1130 includes a programmable logic control (PLC) 1160 to facilitate the coordinated motion between all five drives, proximity sensors, and machine vision sensors 1150. I/O ports of the PLC 1160 are connected to the respective I/O ports of the AC drive 1110 and servo controller 1120 as well as to the proximity sensors 1140 and vision sensors 1150. Control signals (e.g., indexing commands) are now relayed to the AC drive 1110 and the servo controller 1120 (and thus the servos) via the PLC 1160. In this arrangement, the PLC 1160 allows continued data logging of some or all motion and triggering signals obtained from the proximity sensors 1140 and vision sensors 1150. Since the primary interface for the PLC 1160 and vision sensors 1150 may be through an Ethernet connection, a managed Ethernet switch 1170 may be included to connect the PLC 1160 to the other control system components or another computer.

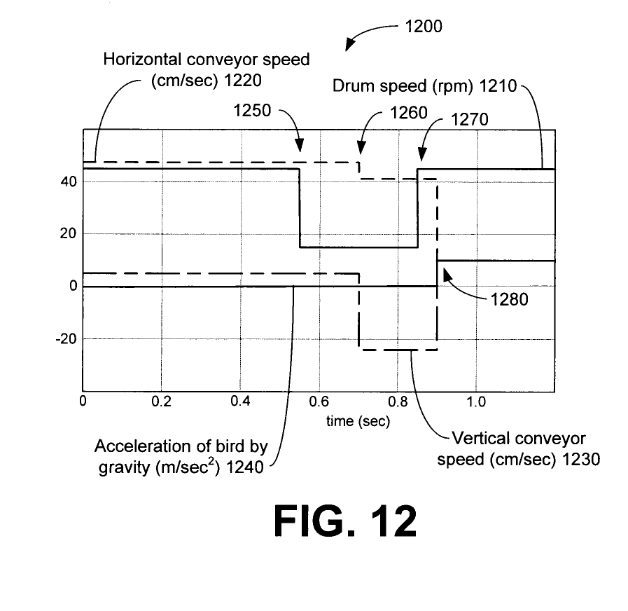

Referring now to FIG. 12, shown is a graphical representation 1200 of the relationships between the drum speed 1210 of the body-grasper 130, the speed of a point on the perch conveyor 110 (e.g., a perch mechanism 250) in the horizontal (X) direction 1220 and the vertical (Y) direction 1230, and the effect of gravity 1240 on the bird.210. To begin, the bird 210 is transported up the incline portion 290 (FIG. 2) of the perch conveyor 110 at a constant horizontal and vertical speed. When the bird 210 is detected by the first proximity sensor, the speed of the rotating drums of the body-grasper 130 is reduced at point 1250 to assist in cradling the bird 210. When the point on the perch conveyor transitions from the incline portion 290 to the decline portion 390 (FIG. 3A) at point 1260, the horizontal speed 1220 and the vertical speed 1230 decreases as the legs of the bird 210 are extended for shackling. Upon detection of leg shackling by the second proximity sensor at point 1270, the speed 1210 of the rotating drums of the body-grasper 130 is returned to its previous condition. The increased drum speed 1210 may also assist in driving the shanks of the bird 210 into the shackle mechanism. As the bird 210 is cleared from the perch mechanism 250 (FIG. 2) of the perch conveyor 110 at point 1280, the bird 210 is no longer supported and gravity accelerates the bird 210 onto the pallet 140.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A live bird transfer system comprising:
a perch conveyor configured to transport a live bird on a perch mechanism from a distal end to a proximal end of the perch conveyor; and
a shackle line comprising:
a pallet assembly including a trolley supporting a pallet; and
a star-wheel mechanism configured to position the trolley such that the pallet is aligned with the proximal end of the perch conveyor during transfer of the live bird from the perch mechanism to the pallet.

2. The live bird transfer system of claim 1, wherein the star-wheel mechanism includes a slot configured to engage a follower of the trolley during positioning of the trolley.

3. The live bird transfer system of claim 2, wherein rotation of the star-wheel mechanism positions the trolley such that the pallet is aligned with the proximal end of the perch conveyor.

4. The live bird transfer system of claim 3, wherein the star-wheel mechanism includes a second slot configured to engage a follower of a second trolley when the first trolley is positioned such that the pallet is aligned with the proximal end of the perch conveyor.

5. The live bird transfer system of claim 4, wherein further rotation of the star-wheel mechanism clears the pallet supported by the first trolley from alignment with the proximal end of the perch conveyor the first trolley and simultaneously positions the second trolley such that a pallet supported by the second trolley is aligned with the proximal end of the perch conveyor.

6. The live bird transfer system of claim 1, further comprising a body-grasper at the proximal end of the perch conveyor, the body-grasper configured to cradle the live bird during transfer of the live bird from the perch mechanism to the pallet.

7. The live bird transfer system of claim 6, further comprising a control system configured to coordinate the movement of the perch conveyor, the star-wheel mechanism, and the body-grasper during transfer of the live bird from the perch mechanism to the pallet.

8. The live bird transfer system of claim 7, wherein the control system includes a vision sensor to provide feedback image information to the control system to coordinate the movement of the perch conveyor and the body-grasper.

9. The live bird transfer system of claim 7, wherein the control system includes a vision sensor to provide feedback image information to the control system to coordinate the movement of the star-wheel mechanism and the body-grasper.

10. The live bird transfer system of claim 6, further comprising virtual exit lighting positioned at the proximal end of the perch conveyor and above the body-grasper.

11. The live bird transfer system of claim 1, wherein the pallet assembly further includes a shackle mechanism configured to shackle the live bird to the pallet during transfer from the perch mechanism.

12. The live bird transfer system of claim 11, wherein the shackle line is configured to invert the live bird after the live bird is shackled to the pallet.

13. The live bird transfer system of claim 1, wherein the shackle line is separate from the perch conveyor.

14. A live bird transfer system comprising:
a perch conveyor configured to transport a live bird from a distal end to a proximal end of the perch conveyor;
a body-grasper at the proximal end of the perch conveyor; and
virtual exit lighting positioned at the proximal end of the perch conveyor and above the body-grasper.

15. The live bird transfer system of claim 14, wherein the virtual exit lighting provides light in the range of about 400 nm to about 700 nm.

16. The live bird transfer system of claim 15, wherein the virtual exit lighting provides blue light in the range of about 425 nm to about 450 nm.

17. The live bird transfer system of claim 14, wherein the virtual exit lighting is an LED array.

18. The live bird transfer system of claim 14, wherein the perch conveyor further comprises a conveyor enclosure extending from the distal end to the proximal end of the perch conveyor, where the virtual exit lighting is positioned at the proximal end of the conveyor enclosure.

19. The live bird transfer system of claim 18, further comprising structured lighting positioned over the distal end of the perch conveyor, the structured lighting configured to provide local illumination of the distal end of the perch conveyor, where the structured lighting provides light in the range of about 400 nm to about 700 nm.

20. The live bird transfer system of claim 19, wherein the structured lighting provides blue light in the range of about 425 nm to about 450 nm.
